(19) United States
(12) Patent Application Publication
(10) Pub. No.: US 2024/0028201 A1
(43) Pub. Date: Jan. 25, 2024

(54) OPTIMAL MEMORY TIERING OF LARGE MEMORY SYSTEMS USING A MINIMAL NUMBER OF PROCESSORS

(71) Applicant: DELL PRODUCTS L.P., Round Rock, TX (US)

(72) Inventor: Stuart Allen Berke, Austin, TX (US)

(21) Appl. No.: 17/868,046

(22) Filed: Jul. 19, 2022

(51) Int. Cl. G06F 3/06

(52) U.S. Cl. CPC G06F 3/061; G06F 3/0655; G06F 3/0679

(57) ABSTRACT

An information handling system includes a compute express link (CXL) multi-port controller (MPC). A first processor includes first memory modules coupled to the first processor. A second processor includes second memory modules coupled to the second processor. The CXL MPC is coupled via a first CXL port to the first processor and is coupled via a second CXL port to the second processor. The CXL MPC includes third memory modules coupled to the CXL MPC. The first memory modules, the second memory modules, and the third memory modules comprise a common cache coherency domain.

### FIELD OF THE DISCLOSURE

This disclosure generally relates to information handling systems, and more particularly relates to providing optimal memory tiering of large memory systems using a minimal number of processors in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include a first processor, a second processor, and a compute express link (CXL) multi-port controller (MPC). The first processor may include first memory modules coupled to the first processor. The second processor may include second memory modules coupled to the second processor. The CXL MPC may be coupled via a first CXL port to the first processor and is coupled via a second CXL port to the second processor. The CXL MPC may include third memory modules coupled to the CXL MPC. The first memory modules, the second memory modules, and the third memory modules may comprise a common cache coherency domain.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of a compute express link (CXL) information handling system according to an embodiment of the current disclosure;

FIG. 2 is block diagram of an information handling system according to the prior art;

FIG. 3 is block diagram of a CXL information handling system according to another embodiment of the current disclosure; and

FIG. 4 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

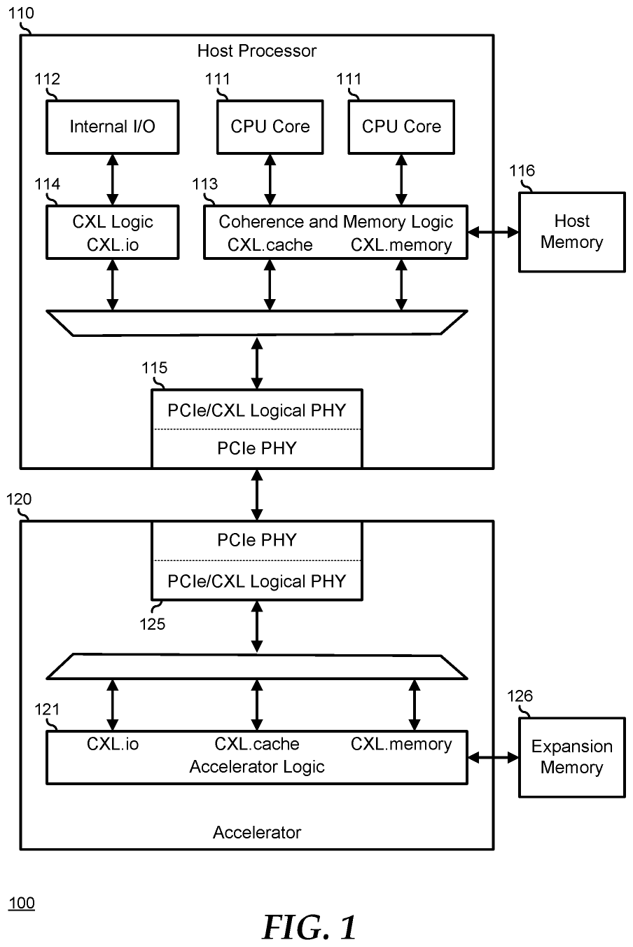

FIG. 1 shows an information handling system 100, including a host processor 110 with associated host memory 116, and an accelerator device 120 with associated expansion memory 126. Host processor 110 includes one or more processor core 111, various internal input/output (I/O) devices 112, coherence and memory logic 113, compute express link (CXL) logic 114, and a PCIe physical layer (PHY) interface 115. Coherence and memory logic 113 provides cache coherent access to host memory 116. The operation of a host processor, and particularly of the component functional blocks within a host processor, are known in the art, and will not be further described herein, except as needed to illustrate the current embodiments.

Accelerator device 120 includes accelerator logic 121, and a PCIe PHY interface 125 that is connected to PCIe PHY interface 115. Accelerator logic 121 provides access to expansion memory 126. Accelerator device 120 represents a hardware device configured to enhance the overall performance of information handling system 100. An examples of accelerator device 120 may include a smart network interface card (MC) or host bus adapter (HBA), a graphics processing unit (GPU), field programmable gate array (FPGA), or application specific integrated circuit (ASIC) device, a memory management and expansion device or the like, or another type of device configured to improve the performance of information handling system 100, as needed or desired. In particular, being coupled to host processor 110 via the PCIe link established between PCIe interfaces 115 and 125, accelerator device 120 may represent a task-based device that receives setup instructions from the host processor, and then independently executes the tasks specified by the setup instructions. In such cases, accelerator device 120 may access host memory 116 via a direct memory access (DMA) device or DMA function instantiated on the host processor. When representing a memory management device, accelerator device 120 may represent a device configured to provide an expanded memory capacity, in the form of expansion memory 126, thereby increasing the overall storage capacity of information handling system 100, or may represent a memory capacity configured to increase the memory bandwidth of the information handling system, as needed or desired.

Information handling system 100 represents an information handling system configured in conformance with a compute express link (CXL) standard, such as a CXL 1.1 specification, a CXL 2.0 specification, or any other CXL standard as may be published from time to time by the CXL Consortium. The CXL standard is an industry-supported interconnection standard that provides a cache-coherent interconnection between processors, accelerator devices, memory expansion devices, or other devices, as needed or desired. In this way, operations performed at diverse locations and by diverse architectures may maintain a memory coherency domain across the entire platform. The CXL standard provides for three (3) related protocols: CXL.io, CXL.cache, and CXL.memory. The CXL.io protocol represents an I/O protocol that is based upon the PCIe 5.0 protocol (for CXL specification 1.1 and 2.0) or the PCIe 6.0 protocol (for CXL specification 3.0).

For example, the CXL.io protocol provides for device discovery, configuration, and initialization, interrupt and DMA handling, and I/O virtualization functions, as needed or desired. The CXL.cache protocol provides for processors to maintain a cache-coherency domain with accelerator devices and their attached expansion memory, and with capacity- and bandwidth-based memory expansion devices, as needed or desired. The CXL.memory protocol permits processors and the like to access memory expansion devices in a cache-coherency domain utilizing load/store-based commands, as needed or desired. Further, the CXL.memory protocol permits the use of a wider array of memory types than may be supported by processor 110. For example, a processor may not provide native support for various types of non-volatile memory devices, such as Intel Optane Persistent Memory, but the targeted installation of an accelerator device that supports Intel Optane Persistent Memory may permit the information handling system to utilize such memory devices, as needed or desired.

In this regard, host processor 110 and accelerator device 120 each include logic and firmware configured to instantiate the CXL.io, CXL.cache, and CXL.memory protocols. In particular, within host processor 110, coherence and memory logic 113 instantiates the functions and features of the CXL.cache and CXL.memory protocols, and CXL logic 114 implements the functions and features of the CXL.io protocol. Further, PCIe PHY 115 instantiates a virtual CXL logical PHY. Likewise, within accelerator device 120, accelerator logic 121 instantiates the CXL.io, CXL.cache, and CXL.memory protocols, and PCIe PHY 125 instantiates a virtual CXL logical PHY. Within a CXL enabled accelerator device such as accelerator device 120, both the CXL.cache and CXL.memory protocols do not have to be instantiated, as needed or desired, but any CXL enabled accelerator device must instantiate the CXL.io protocol.

In a particular embodiment, the CXL standard provides for the initialization of information handling system 100 with a heavy reliance on existing PCIe device and link initialization processes. In particular, when information handling system 100 is powered on, the PCIe device enumeration process operates to identify accelerator 120 as a CXL device, and that the operations of the accelerator, in addition to providing for standard PCIe operation, functions, and features, may be understood to provide for additional CXL operation, functions, and features. For example, accelerator 120 will be understood to enable CXL features such as global memory flush, CXL reliability, availability, and serviceability (RAS) features, CXL metadata support, and the like. In addition to the enablement of the various CXL operation, functions, and features, accelerator 120 enables operations at higher interface speeds, such as 16 giga-transfers per second (GT/s) or 32 GT/s.

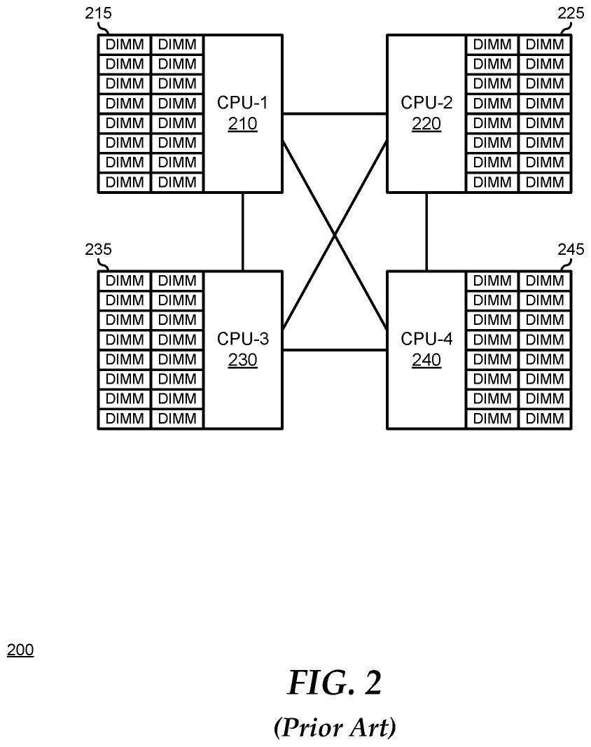

FIG. 2 illustrates an information handling system 200 according to the prior art, including processors 210, 220, 230, and 240. Information handling system 200 represents a four (4) processor socket system configured with a large memory capacity as may typically be utilized for large database management applications, Graph-type artificial intelligence applications, or other types of analytics applications. Each of processors 210 will be understood to support eight (8) independent memory channels, each memory channel being populated with two (2) dual in-line memory modules (DIMMs). Thus processors 210, 220, 230, and 240 are each illustrated as being populated with 16 DIMMs 215, 225, 235, and 245, respectively, for a total of 64 DIMMs in information handling system 200. In a particular example, where each DIMM has a memory capacity of 128 gigabytes (GB), information handling system 200 has an eight (8) terabyte (TB) memory capacity.

Processors 210, 220, 230, and 240 are illustrated as being connected together by separate point-to-point interfaces. In this way, the memory capacity of information handling system 200 represents a common cache domain, and cache coherency is maintained across DIMMs 215, 225, 235, and 245. In terms of memory latency, each processor thus includes 16 DIMMs that are accessible at the latency of the on-board memory controllers, and includes 48 DIMMs that are accessible at with the added latency of a single (1) hop of a point-to-point interface. Processors 210, 220, 230, and 240 may represent general purpose processors, such as processors from Intel, AMD, Arm, or the like. Examples of point-to-point interfaces may include Intel UltraPath Interconnect (UPI) interfaces, AMD External Global Memory Interconnect aka Infinity Fabric) xGMI interfaces, or the like. DIMMs 215, 225, 235, and 245 are typically provided in accordance with a particular double data rate (DDR) standard, such as a third generation DDR (DDR3) standard, a fourth generation DDR (DDR4) standard, a fifth generation DDR (DDR5) standard, or the like.

Future usage models for the typical applications utilizing large memory capacity systems project the demand for coherent, low-latency memory capacity on the order of hundreds of terabytes. As such, the need to scale up information handling systems to eight (8), 16, or even 32 sockets is likely. However, as the number of sockets increases, the latency associated with such large memory capacity systems increases as well. Thus where an information handling system is an eight (8) socket system, 128 DIMMs may be supported, but each processor may include 16 DIMMs that are accessible at the latency of the on-board memory controllers, 48 DIMMs that are accessible at with the added latency of a single (1) hop of a point-to-point interface, and 64 DIMMs that are accessible through two (2) hops. Moreover, as the number of sockets increases, the proportion of the processing power of each processor that is utilized in coherency transactions or is otherwise stalled due to coherency traffic also increases, thereby reducing the utilization of the associated processors. Further, the processor power budget of such large capacity systems may limit the performance of the individual processors, thereby decreasing the utilization even further. Table 1 illustrates the latencies involved in several common high memory capacity systems

TABLE 1
Multi-Socket Systems

| | Total | Capacity (128 | Resident | 1-Hop | 2-Hop |
|---|---|---|---|---|---|
| Sockets | DIMMs | GB DIMMs) | DIMMs | DIMMs | DIMMs |
| 2 | 32 | 4 TB | 16 | 16 | 0 |
| 4 | 64 | 8 TB | 16 | 48 | 0 |
| 8 | 128 | 16 TB | 16 | 48 | 64 |

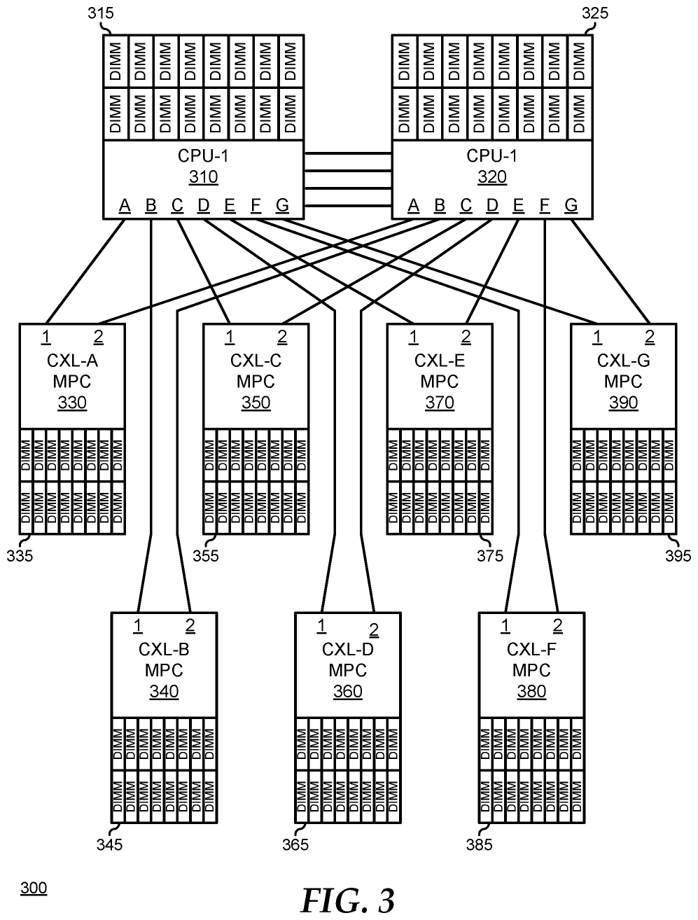

FIG. 3 illustrates an information handling system 300, including processors 310 and 320, similar to processors 210, 220, 230, and 240. Information handling system 300 further includes CXL multi-port memory controllers (MPCs) 330, 340, 350, 360, 370, 380, and 390. Information handling system 300 represents a two (2) processor socket system configured with a large memory capacity. In particular, processors 310 and 320 are each illustrated as being populated with 16 DIMMs 315 and 325, respectively, and MPCs 330, 340, 350, 360, 370, 380, and 390 are each illustrated as being populated with 16 DIMMs 335, 345, 355, 365, 375, 385, and 395, respectively, for a total of 144 DIMMs in information handling system 300. Where each DIMM has a memory capacity of 128 gigabytes (GB), information handling system 300 has an eighteen (18) terabyte (TB) memory capacity

Processors 310, 320 are illustrated as being connected together by separate point-to-point interfaces. In this way, the memory capacity of information handling system 300 represents a common cache domain, and cache coherency is maintained across DIMMs 315, 325, 335, 345, 355, 365, 375, 385, and 395. In terms of memory latency, each processor thus includes 16 DIMMs that are accessible at the latency of the on-board memory controllers, and includes 128 DIMMs that are accessible at with the added latency of a single (1) hop of a point-to-point interface. Processors 310 and 320 may represent general purpose processors, such as processors from Intel, AMD, Arm, or the like, and point-to-point interfaces may include Intel UltraPath Interconnect (UPI) interfaces, AMD External Global Memory Interconnect aka Infinity Fabric (xGMI) interfaces, or the like. DIMMs 315, 325, 335, 345, 355, 365, 375, 385, and 395 are typically provided in accordance with a particular double data rate (DDR) standard, such as a third generation DDR (DDR3) standard, a fourth generation DDR (DDR4) standard, a fifth generation DDR (DDR5) standard, or the like.

Information handling system 300 utilizes memory tiering functions and memory cache coherency functions from a particular CXL standard, such as the CXL 2.0 standard or the CXL 3.0 standard. As illustrated, the seven (7) CXL MPCs 330, 340, 350, 360, 370, 380, and 390, in conjunction with processors 310 and 320, represent a conceivable topology given current and near-future processor interconnection capabilities. That is, the likely connection footprint, such as may be provided for a socketed processor, can typically support the interconnection of up to seven connected devices, in addition to the supported DIMM density. As such, even as compared with the eight (8) socket system as shown in Table 1, information handling system 300 provides a larger memory capacity (18 TB vs. 16 TB). However, in terms of latency, information handling system 300 does not have any 2-hop latencies, as may be the case for the eight (8) socket system as described above. Further, in terms of cost, the two (2) socket system of information handling system 300 necessitates six (6) fewer processors, and the two (2) processors will be more highly utilized. Thus information handling system 300 provides greater memory capacity at a lower cost than typical information handling systems with similarly sized memory capacities.

In a particular embodiment, an information handling system similar to information handling system 300 is provided, but where more than seven (7) CXL MPCs are included. In order to meet such an extreme fan out of memory capacity, one or more CXL switches, as may be provided in a CXL standard, such as the CXL 2.0 standard or the CXL 3.0 standard, are connected to the processors, and each CXL switch is connected to multiple CXL MPCs. It will be understood that the inclusion of a CXL switch is substantially equivalent to an additional hop of a inter-processor point-to-point interface, and so the increased memory capacity would be achieved at the cost of greater latencies, but the potential for greatly increased memory capacities would still be achievable utilizing only a two (2) socket information handling system. Thus the advantages as described above for information handling system 300 are easily scaled to systems with much larger memory capacities, as needed or desired.

In another embodiment, an information handling system that utilizes CXL switches to expand the memory capacity, as described above, utilizes CXL memory tiering, wherein the logical location of various memory blocks are tracked and can be stored within the memory capacity in logical locations that are closer to the processors that most commonly call on those memory blocks. In this way, the necessity to access memory blocks with greater numbers of hops can be intelligently managed to improve overall system performance.

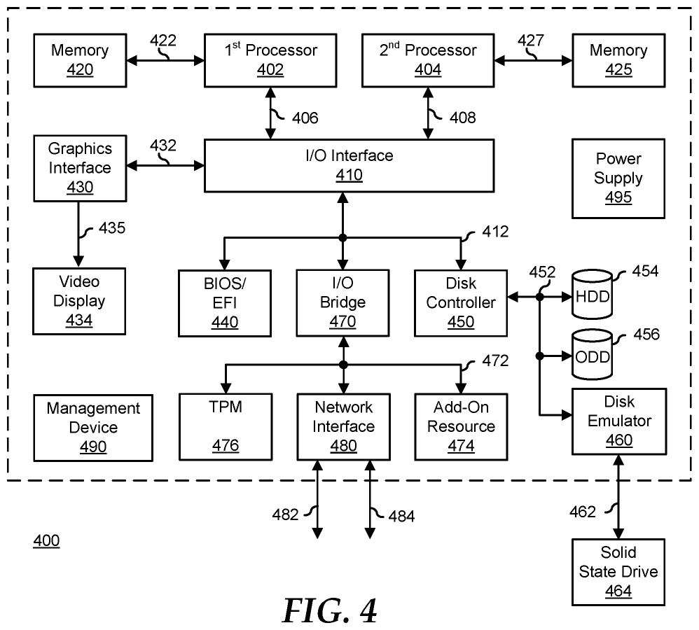

FIG. 4 illustrates a generalized embodiment of an information handling system 400. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 400 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 400 can include processing resources for executing machine-executable code, such as a central processing unit (CPU), a programmable logic array (PLA), an embedded device such as a System-on-a-Chip (SoC), or other control logic hardware. Information handling system 400 can also include one or more computer-readable medium for storing machine-executable code, such as software or data. Additional components of information handling system 400 can include one or more storage devices that can store machine-executable code, one or more communications ports for communicating with external devices, and various input and output (I/O) devices, such as a keyboard, a mouse, and a video display. Information handling system 400 can also include one or more buses operable to transmit information between the various hardware components.

Information handling system 400 can include devices or modules that embody one or more of the devices or modules described below, and operates to perform one or more of the methods described below. Information handling system 400 includes a processors 402 and 404, an input/output (I/O) interface 410, memories 420 and 425, a graphics interface 430, a basic input and output system/universal extensible firmware interface (BIOS/UEFI) module 440, a disk controller 450, a hard disk drive (HDD) 454, an optical disk drive (ODD) 456, a disk emulator 460 connected to an external solid state drive (SSD) 462, an I/O bridge 470, one or more add-on resources 474, a trusted platform module (TPM) 476, a network interface 480, a management device 490, and a power supply 495. Processors 402 and 404, I/O interface 410, memory 420 and 425, graphics interface 430, BIOS/UEFI module 440, disk controller 450, HDD 454, ODD 456, disk emulator 460, SSD 462, I/O bridge 470, add-on resources 474, TPM 476, and network interface 480 operate together to provide a host environment of information handling system 400 that operates to provide the data processing functionality of the information handling system. The host environment operates to execute machine-executable code, including platform BIOS/UEFI code, device firmware, operating system code, applications, programs, and the like, to perform the data processing tasks associated with information handling system 400.

In the host environment, processor 402 is connected to I/O interface 410 via processor interface 406, and processor 404 is connected to the I/O interface via processor interface 408. Memory 420 is connected to processor 402 via a memory interface 422. Memory 425 is connected to processor 404 via a memory interface 427. Graphics interface 430 is connected to I/O interface 410 via a graphics interface 432, and provides a video display output 435 to a video display 434. In a particular embodiment, information handling system 400 includes separate memories that are dedicated to each of processors 402 and 404 via separate memory interfaces. An example of memories 420 and 430 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 440, disk controller 450, and I/O bridge 470 are connected to I/O interface 410 via an I/O channel 412. An example of I/O channel 412 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 410 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 440 includes BIOS/UEFI code operable to detect resources within information handling system 400, to provide drivers for the resources, initialize the resources, and access the resources. BIOS/UEFI module 440 includes code that operates to detect resources within information handling system 400, to provide drivers for the resources, to initialize the resources, and to access the resources.

Disk controller 450 includes a disk interface 452 that connects the disk controller to HDD 454, to ODD 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an IEEE 1394 (Firewire) interface, a proprietary interface, or a combination thereof. Alternatively, solid-state drive 464 can be disposed within information handling system 400.

I/O bridge 470 includes a peripheral interface 472 that connects the I/O bridge to add-on resource 474, to TPM 476, and to network interface 480. Peripheral interface 472 can be the same type of interface as I/O channel 412, or can be a different type of interface. As such, I/O bridge 470 extends the capacity of I/O channel 412 when peripheral interface 472 and the I/O channel are of the same type, and the I/O bridge translates information from a format suitable to the I/O channel to a format suitable to the peripheral channel 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on separate circuit board or add-in card disposed within information handling system 400, a device that is external to the information handling system, or a combination thereof.

Network interface 480 represents a NIC disposed within information handling system 400, on a main circuit board of the information handling system, integrated onto another component such as I/O interface 410, in another suitable location, or a combination thereof. Network interface device 480 includes network channels 482 and 484 that provide interfaces to devices that are external to information handling system 400. In a particular embodiment, network channels 482 and 484 are of a different type than peripheral channel 472 and network interface 480 translates information from a format suitable to the peripheral channel to a format suitable to external devices. An example of network channels 482 and 484 includes InfiniBand channels, Fibre Channel channels, Gigabit Ethernet channels, proprietary channel architectures, or a combination thereof. Network channels 482 and 484 can be connected to external network resources (not illustrated). The network resource can include another information handling system, a data storage system, another network, a grid management system, another suitable resource, or a combination thereof.

Management device 490 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 400. In particular, management device 490 is connected to various components of the host environment via various internal communication interfaces, such as a Low Pin Count (LPC) interface, an Inter-Integrated-Circuit (I2C) interface, a PCIe interface, or the like, to provide an out-of-band (00B) mechanism to retrieve information related to the operation of the host environment, to provide BIOS/UEFI or system firmware updates, to manage non-processing components of information handling system 400, such as system cooling fans and power supplies. Management device 490 can include a network connection to an external management system, and the management device can communicate with the management system to report status information for information handling system 400, to receive BIOS/UEFI or system firmware updates, or to perform other task for managing and controlling the operation of information handling system 400. Management device 490 can operate off of a separate power plane from the components of the host environment so that the management device receives power to manage information handling system 400 when the information handling system is otherwise shut down. An example of management device 490 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 490 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system, comprising:
first memory modules coupled to a first processor;
second memory modules coupled to a second processor; and
a first compute express link (CXL) multi-port controller (MPC) coupled via a first CXL port to the first processor and coupled via a second CXL port to the second processor, the first CXL MPC including third memory modules coupled to the first CXL MPC, wherein the first memory modules, the second memory modules, and the third memory modules comprise a common cache coherency domain.

2. The information handling system of claim 1, further comprising a second CXL MPC coupled via a third CXL port to the first processor and coupled via a fourth CXL port to the second processor, the second CXL MPC including fourth memory modules coupled to the second CXL MPC, wherein the fourth memory modules are included in the cache coherency domain.

3. The information handling system of claim 1, wherein:
the first processor includes a number (N) of first CXL interfaces; and
the second processor includes the number (N) of second CXL interfaces.

4. The information handling system of claim 3, wherein the first CXL port is coupled to a first one of the first CXL interfaces, and wherein the second CXL port is coupled to a first one of the second CL interfaces.

5. The information handling system of claim 4, further comprising a number (N-1) of additional CXL MPCs, wherein each particular additional CXL MCP includes respective additional memory modules coupled to the particular additional CXL MPC.

6. The information handling system of claim 5, wherein each particular additional CXL MPC includes a respective third CXL port and a respective fourth CXL port.

7. The information handling system of claim 6, wherein each third CXL port is coupled to an associated one of the first CXL interfaces, and wherein each fourth CXL port is coupled to an associated one of the second CXL interfaces.

8. The information handling system of claim 7, wherein all of the additional memory modules are included in the cache coherency domain.

9. The information handling system of claim 1, wherein the first processor and the second processor are coupled together by an inter-processor interface.

10. The information handling system of claim 9, wherein the inter-processor interface includes one of an Intel UltraPath Interconnect (UPI) interface and an AMD External Global Memory Interconnect (xGMI) interface.

11. A method, comprising:
providing, on an information handling system, a first processor coupled to first memory modules;
providing, on the information handling system, a second processor coupled to second memory modules;
providing a first compute express link (CXL) multi-port controller (MPC) coupled to third memory modules;
coupling, via a first CXL port of the first CXL MPC, the first CXL MPC to the first processor;
coupling, via a second CXL port of the first CXL MPC, the first CXL MPC to the second processor; and
providing a cache coherency domain for the information handling system, the cache coherency domain including the first memory modules, the second memory modules, and the third memory modules.

12. The method of claim 11, further comprising providing a second CXL MPC coupled to fourth memory modules, wherein the cache coherency domain further includes the fourth memory modules.

13. The method of claim 11, wherein:
the first processor includes a number (N) of first CXL interfaces; and
the second processor includes the number (N) of second CXL interfaces.

14. The method of claim 13, wherein the first CXL port is coupled to a first one of the first CXL interfaces, and wherein the second CXL port is coupled to a first one of the second CL interfaces.

15. The method of claim 14, further comprising providing a number (N-1) of additional CXL MPCs, wherein each particular additional CXL MCP includes respective additional memory modules coupled to the particular additional CXL MPC.

16. The method of claim 15, wherein each particular additional CXL MPC includes a respective third CXL port and a respective fourth CXL port.

17. The method of claim 16, further comprising:
coupling each third CXL port to an associated one of the first CXL interfaces; and
coupling each fourth CXL port to an associated one of the second CXL interfaces.

18. The method of claim 17, wherein all of the additional memory modules are included in the cache coherency domain.

19. The method of claim 11, further comprising coupling the first processor and the second processor together by an inter-processor interface.

20. An information handling system, comprising:
first memory modules coupled to a first processor;
second memory modules coupled to a second processor, wherein the first processor and the second processor are connected by an inter-processor interface;
a first compute express link (CXL) multi-port controller (MPC) coupled via a first CXL port to the first processor and coupled via a second CXL port to the second processor, the first CXL MPC including third memory modules coupled to the first CXL MPC, wherein the first memory modules, the second memory modules, and the third memory modules comprise a common cache coherency domain; and
a second CXL MPC coupled via a third CXL port to the first processor and coupled via a fourth CXL port to the second processor, the second CXL MPC including fourth memory modules coupled to the second CXL MPC, wherein the fourth memory modules are included in the cache coherency domain.
